(19) United States
(12) Patent Application Publication
(10) Pub. No.: US 2004/0081852 A1
(43) Pub. Date: Apr. 29, 2004

(54) HYGROSCOPIC PASSIVATION STRUCTURE OF AN ORGANIC ELECTROLUMINESCENT DISPLAY

(76) Inventors: Kuang-Jung Chen, Taipei City (TW); Heng-Long Yang, Taipei City (TW)

Correspondence Address: NAIPO (NORTH AMERICA INTERNATIONAL PATENT OFFICE), P.O. BOX 506, MERRIFIELD, VA, 22116, US

(21) Appl. No.: 10/249,888

(22) Filed: May 15, 2003

(30) Foreign Application Priority Data
Oct. 24, 2002 (TW) 091124830

(51) Int. Cl. B32B 9/00

(52) U.S. Cl. 428/690; 428/426; 428/689; 428/469

(57) ABSTRACT

A hygroscopic passivation structure covering a display region of an organic electroluminescent display (OELD) includes at least one buffer layer, a hygroscopic material layer, and a passivation layer. The hygroscopic material is used to adsorb moisture that is generated internally from the OELD and is penetrated through the outer passivation layer.

### BACKGROUND OF INVENTION

1. Field of the Invention

The present invention relates to a passivation structure of an organic light emitting device, and more particularly, to a hygroscopic passivation structure of an active matrix type organic electroluminescent display (AM-OELD) and a passive matrix type organic electroluminescent display (PM-OELD).

2. Description of the Prior Art

In various types of flat panel displays, since an OELD has many beneficial characteristics, such as having a spontaneous light source, a wide viewing angle, highresponse velocity, full-color, simpler structure, a wide operating temperature, and power savings, the OELD has been used extensively in small and medium scale portable display fields.

Please refer to FIG. 1, which is a cross-sectional view illustrating a conventional OELD 10. As shown in FIG. 1, the conventional OELD 10 mainly includes a substrate 12, a transparent conductive layer 14 positioned on the substrate 12, an organic layer 16 positioned on a predetermined region of the transparent conductive layer 14, and a metal layer 18 positioned on the organic layer 16. The transparent conductive layer 14 is used as an anode of the OELD 10, and the metal layer 18 is used as a cathode of the OELD 10. The organic layer 16 and the metal layer 18 of the OELD 10 are very sensitive to moisture and oxygen gas. As soon as the organic layer 16 and the metal layer 18 are in contact with moisture and oxygen gas, the organic layer 16 could peel off the transparent conductive layer 14 and the metal layer 18, the metal layer 18 could be oxidized, and dark spots could be generated in the OELD 10, reducing display quality, lowering glow of the OELD 10, and decreasing life of the OELD 10. Therefore, a passivation and encapsulation material of the OELD 10 must have characteristics of perfect anti-abrasiveness, high thermal conductivity, and lower moisture permeability, to prevent the organic layer 16 and the metal layer 18 from contacting with the outside environment efficiently, and to increase the life of the OELD 10.

Please refer to FIG. 1 again, an encapsulation process of the conventional OELD 10 utilizes a sealing material 20, such as a binder composed of high polymer glue materials, to bind a container 22 made of glass or metal on the substrate 12. Then, dry nitrogen gas is injected into a hollow part between the container 22 and the substrate 12 to prevent moisture from penetrating into the OELD 10. However, an internal part of the OELD 10 still contains a small amount of moisture adhering on a surface of the substrate 12 or the container 22 after the encapsulation process is performed. Once the OELD 10 is in a high temperature state of about 100° C., the moisture adhering on the substrate 12 and the container 22 will release into the internal part of the OELD 10 to generate the dark spots in the OELD 10. In order to solve this problem, a desiccating agent 24, such as barium oxide (BaO 2) or calcium oxide (CaO 2), can be positioned in the OELD 10 and used as a hygroscopic agent to adsorb the moisture to sustain the internal part of the OELD 10 to be in a dry state.

However, the above-mentioned container cannot be applied in a flexible OELD. The metal container has disadvantages of having heavy weight, being oxidized easily, and peeling off the glass easily, and the glass container has disadvantages of inconvenient extra working, cracking easily, having large size, and having heavy weight. Additionally, the conventional binder composed of high polymer glue materials does not have enough protection ability about moisture, and the moisture could penetrate from the outside environment through the binder and into the OELD after completing the encapsulation process, leading to erosion of the display device, affecting the display quality, and reducing the life of the display. Furthermore, the conventional encapsulation process cannot be performed in a vacuum state, so that the internal part of the OELD easily retains more moisture and other gas.

In order to solve the above-mentioned problems of the metal or glass container, a new passivation process that utilizes films to encapsulate the OELD is disclosed in U.S. Pat. No. 5,811,177. Please refer to FIG. 2, which is a cross-sectional view illustrating another conventional OELD 30. As shown in FIG. 2, the conventional OELD 30 mainly includes a substrate 32, a display device 34 positioned on the substrate 32, and a passivation structure 36 covering the display region 34 and the substrate 32. The display device 34 is composed of a plurality of display units (not shown in FIG. 2), and each display unit includes a transparent conductive layer, an organic layer, and a metal layer positioned on the substrate 32, respectively. The passivation structure 36 is a multi-level film structure, and includes a metal layer 38, a buffer layer 40, a thermal coefficient matching layer 42, a low permeability layer 44, and a sealing layer 46 covering the display device 34, respectively, to protect the display device 34.

Briefly, the conventional passivation structure 36 utilizes ceramic materials, metal materials, and high polymer materials as passivation films to prevent the moisture and oxygen gas from penetrating from the outside environment into the display device 34. However, if the OELD 30 is operating in a high temperature environment for a long time, even though the passivation films are utmost without pin holes in the passivation films, a small amount of moisture will be generated from internal devices of the OELD, such as the substrate 32, the organic layer or other materials. The moisture cannot be eliminated, leading to an inferior quality and reducing life of the OELD 30.

Therefore, another moisture-proof multi-layer structure is disclosed in Chinese Taipei Patent 379,531 to improve the above-mentioned problem. The structure includes a moisture-adsorbing resin layer, an adhesive layer, and a transparent resin layer and covers an electroluminescent element (EL) to prevent the EL from moistening and oxidizing. The moisture-adsorbing resin layer is composed of intrinsic moisture-adsorbing resin materials, such as polyvinyl alcohol (PVA), polyvinyl ester saponification agents, or moisture-adsorbing resin materials composed of non-moisture adsorbing resin and hydroscopic chemical compounds. Furthermore, the moisture-adsorbing resin layer has to be dried to reduce the hydrous quality before using the moisture-adsorbing resin layer in the structure of the EL. Since the moisture-adsorbing resin is a physical adsorption material, the moisture adsorbed in the moisture-adsorbing resin will be released easily into an internal part of the EL if the moisture-adsorbing resin is heated. Therefore, the moisture-proof multi-layer structure is only suitable for using in an inorganic EL or a low-level organic EL, but not in high-level organic EL.

### SUMMARY OF INVENTION

It is therefore a primary objective of the claimed invention to provide a hygroscopic passivation film suitable for use in a high-level active matrix type and a passive matrix type organic light emitting device.

It is another object of the claimed invention to provide a hygroscopic passivation structure applied in a top emission type organic electroluminescent display.

According to the preferred embodiment of the claimed invention, a hygroscopic passivation structure of an organic electroluminescent display (OELD) covers a display region of the OELD, and comprises a buffer layer positioned on the display region, a hygroscopic material layer positioned on the buffer layer, and a passivation layer positioned on the hygroscopic material layer.

Since the hygroscopic material layer of the claimed invention can trap moisture penetrated through the outer passivation layer and small amounts of moisture generated internally from the OELD by chemical adsorption. Therefore, the organic layer and the electrode materials of the OELD are not destroyed by the moisture. In addition, the moisture trapped in the hygroscopic material layer is not only stored in the hygroscopic material layer, but a hydroxide chemical compound is generated when the hygroscopic material reacts to the moisture. Consequently, the moisture trapped in the hygroscopic material layer is not released when the OELD is in a high-temperature state, so as to increase the life of the OELD.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a cross-sectional view illustrating a conventional OELD.

FIG. 2 is a cross-sectional view illustrating another conventional OELD.

FIG. 3 is a cross-sectional view illustrating a hygroscopic passivation structure of an OLED according to the present invention.

FIG. 4 to FIG. 10 are local amplified diagrams of the hygroscopic passivation structure of the OLED shown in FIG. 3.

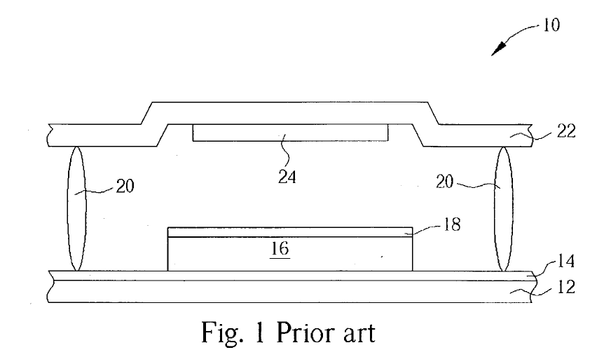

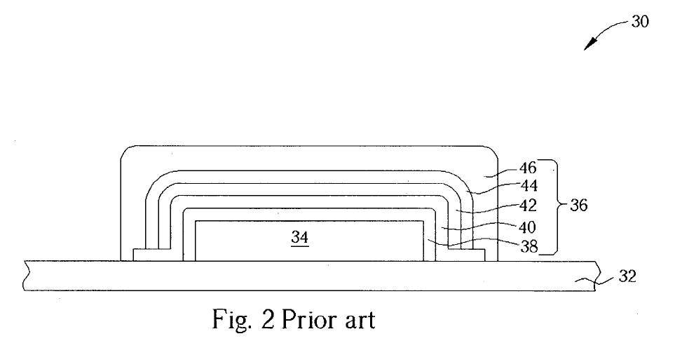

### DETAILED DESCRIPTION

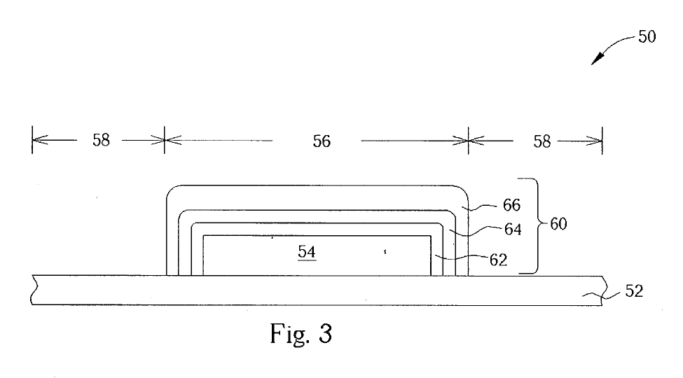

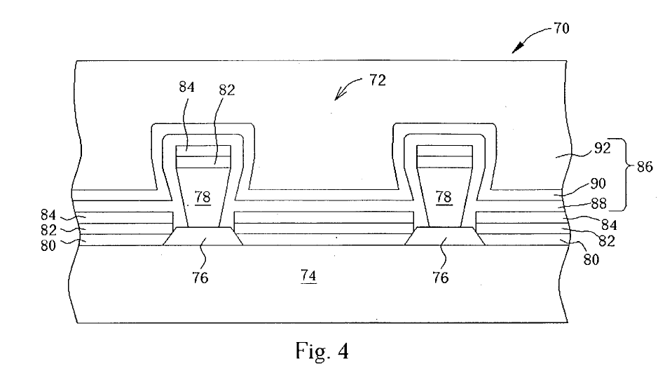

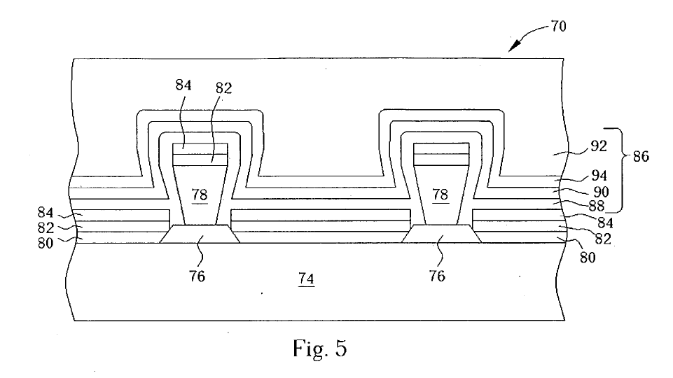

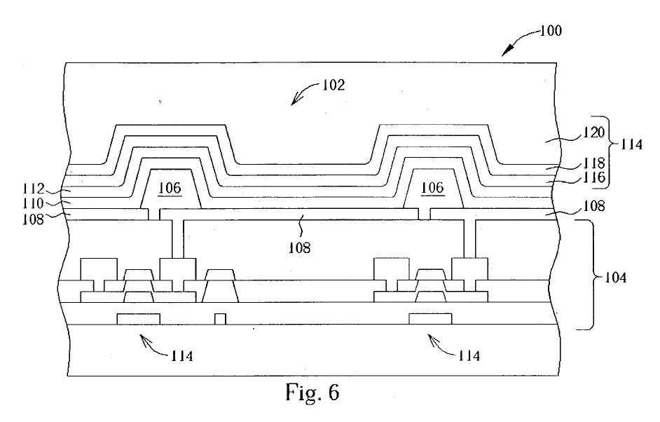

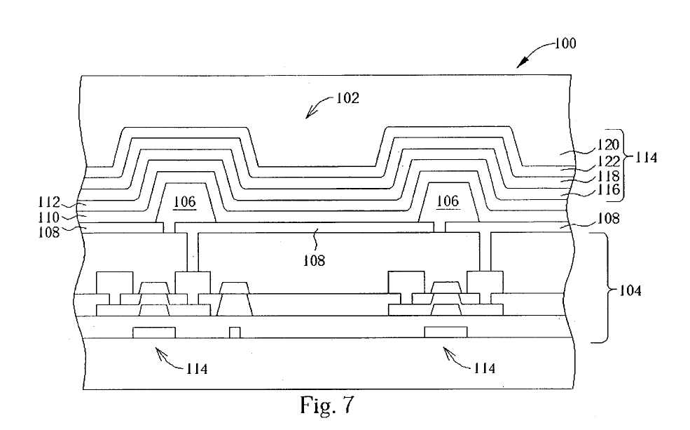

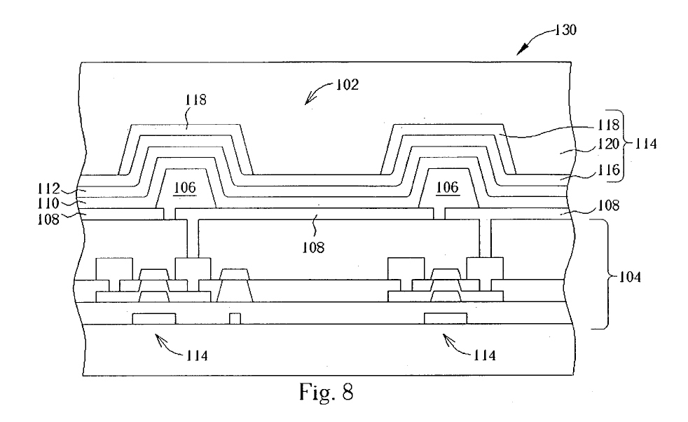

In the preferred embodiment of the present invention, an organic light emitting diode (OLED) is utilized as an example. However, the present invention is not limited to this. A hygroscopic passivation structure of the present invention can be applied in various organic light emitting devices, such as a polymer light emitting diode (PLED). Please refer to FIG. 3 to FIG. 10. FIG. 3 is a cross-sectional view illustrating a hygroscopic passivation structure 60 of an OLED 50 according to the present invention. FIG. 4 to FIG. 10 are local amplified diagram of the hygroscopic passivation structure 60 of the OLED 50 shown in FIG. 3. Specifically, FIG. 4 and FIG. 5 are cross-sectional views illustrating a passive matrix type OLED (PM-OLED) 70 according to the present invention. FIG. 6 and FIG. 7 are cross-sectional views illustrating an active matrix type OLED (AM-OLED) 100 according to the present invention. FIG. 8 is a cross-sectional view illustrating a top emission type OLED (TM-OLED) 130 according to the present invention.

As shown in FIG. 3, the OLED 50 mainly includes a substrate 52, a display device 54 positioned on the substrate 52 to define a display region 56 and a peripheral region 58, and a hygroscopic passivation structure 60 covering the display region 56 of the OLED 50. Specifically, the hygroscopic passivation structure 60 mainly includes a buffer layer 62 positioned on the display unit 54, a hygroscopic material layer 64 positioned on the buffer layer 62, and a passivation layer 66 positioned on the hygroscopic material layer 64 to prevent the display region 54 from being in contact with outside environment.

The hygroscopic passivation structure 60 of the present invention can be applied in various passive type light emitting devices. As shown in FIG. 4, when the display device 54 of the OLED 50 is composed of a plurality of passive matrix type display units 72, the OLED 50 is called a passive matrix type OLED (PM-OLED) 70. The PM-OLED 70 is formed on a substrate 74, and the display units 72 are separated by a plurality of insulating layers 76 and a plurality of ribs 78. Each display unit 72 includes a transparent conductive layer 80 functioning as an anode of the PM-OLED 70 positioned on the substrate 74, an organic layer 82 positioned on the transparent conductive layer 80 and the ribs 78, and a metal layer 84 functioning as a cathode of the PM-OLED positioned on the organic layer 82. Typically, the substrate 74 can be a glass substrate, a plastic substrate, or a metal substrate. The insulating layer 76 and the ribs 78 can be both composed of polymer or inorganic materials. The transparent conductive layer 80 can be composed of indium tin oxide (ITO) or indium zinc oxide (IZO). The metal layer 84 can be composed of magnesium (Mg), aluminum (Al), lithium (Li), or an alloy of Mg, Al, and Li. Additionally, the organic layer 82 further includes a hole transport layer (HTL, not shown in FIG. 4) positioned on the transparent conductive layer 80, an emitting layer(EML, not shown in FIG. 4) positioned on the HTL, and an electron transport layer (ETL, not shown in FIG. 4) positioned on the EML.

Furthermore, the PM-OLED 70 includes a hygroscopic passivation structure 86 covering the display units 72. The hydroscopic passivation structure 86 mainly includes a buffer layer 88 positioned on the display region of the substrate 74, a hydroscopic material layer 90 positioned on the buffer layer 88, and a passivation layer 92 positioned on the hydroscopic material layer 90. The hygroscopic material layer 90 is used to adsorb moisture generated internally from the PM-OLED 70 and penetrated through the passivation layer 92, and the buffer layer 88 is used to prevent from affecting normal operation of the PM-OLED 70 when the hydroscopic material layer 90 reacts to the moisture. The detailed method for forming the hygroscopic passivation structure 90 is stated as below. First, a chemical vapor deposition (CVD) process is performed to form a buffer layer 88 on the substrate 74. Then, a reaction ion etching (RIE) process is performed to remove a portion of the buffer layer outside the display region by utilizing a mask, as shown in FIG. 3. After that, a thermal plating process or an electron beam thermal plating process is performed to form a hygroscopic material layer 90 on the buffer layer 88, and a passivation layer 92 is plated on the hygroscopic material layer 90 to accomplish the hygroscopic passivation structure 86 of the present invention. Typically, the buffer layer 88 is composed of polymer-like materials, such as parylene or diamond-like carbon (DLC). The buffer layer 88 has a thickness of approximately 1 angstrom (Å) to 100 micrometers (μm), and 10 Å to 10 μm is preferred. The hygroscopic material layer 90 is composed of calcium oxide (CaO), barium oxide (BaO), or magnesium oxide (MgO), and has a thickness of approximately 1 Å to 100 μm, and 10 Å to 10 μm is preferred. The passivation layer 92 is composed of polymer materials, ceramic materials, or metal, and the polymer materials are preferred to enhance adhesion ability with the hygroscopic material layer 90. In addition, when the buffer layer 88 is composed of the DLC, the buffer layer 88 can be formed by performing a CVD process with a bias voltage and a mask to plate the buffer layer 88 on the metal layer 84.

That is to say, the hydroscopic material layer 90 comprises alkaline-earth metal oxides. Since the alkaline-earth metal oxides are chemical adsorption materials, hydroxides, such as barium hydroxide (Ba(OH)₂), magnesium hydroxide (Mg(OH)₂), or calcium hydroxide (Ca(OH)₂) will be generated after the hydroscopic material layer 90 reacts to the moisture. Therefore, the moisture trapped in the hygroscopic material layer 90 will not be released into the PM-OLED 70 due to the environment temperature variations, and will not affect normal operation of the display units 72 of the PM-OLED 70. Furthermore, the hydroscopic material layer 90 could be capped with the buffer layer 88 to prevent the hydroscopic material layer 90 from peeling off when the hydroscopic material layer 90 reacts to the moisture. Moreover, another buffer layer 94 could be positioned between the hydroscopic material layer 90 and the passivation layer 92, as shown in FIG. 5, to prevent the moisture and oxygen gas from penetrating into the PM-OLED 70 efficiently.

As shown in FIG. 6, the hygroscopic passivation structure 60 can also be applied in various active type light emitting devices. When the display device 54 of the OLED 50 is composed of a plurality of active matrix type display units 102, the OLED 50 is called an active matrix type OLED (AM-OLED) 100. The AM-OLED 100 is formed on a thin film transistor (TFT) substrate 104, and the display units 102 are separated by a plurality of insulating layers 106. Each display unit 102 includes a transparent conductive layer 108 functioning as an anode of the AM-OLED 100 positioned on the TFT substrate 104, an organic layer 110 positioned on the transparent conductive layer 108 and the insulating layers 106, and a metal layer 112 functioning as a cathode of the AM-OLED 100 positioned on the organic layer 110. Typically, the TFT substrate 104 includes a glass substrate, a plastic substrate, or a metal substrate. The insulating layers 106 can be composed of polymer or inorganic materials. The transparent conductive layer 108 can be composed of ITO or IZO. The metal layer 112 is composed of Mg, Al, Li, or an alloy of Mg, Al, and Li. In addition, each display unit 102 further includes a TFT 114 positioned under and electrically connected to the corresponding display unit 102.

Furthermore, the AM-OLED 100 includes a hygroscopic passivation structure 114 covering the display region of the AM-OLED 100. The hydroscopic passivation structure 114 mainly includes a buffer layer 116 positioned on the metal layer 112, a hydroscopic material layer 18 positioned on the buffer layer 116, and a passivation layer 120 positioned on the hydroscopic material layer 118. The hygroscopic material layer 118 is used to adsorb moisture generated internally from the AM-OLED 100 and penetrated through the passivation layer 120, and the buffer layer 116 is used to prevent from affecting normal operation of the AM-OLED 100 when the hydroscopic material layer 118 reacts to the moisture. The method for forming the hygroscopic passivation structure 114 is the same with the hygroscopic passivation structure 86, and is not repeated again. Similarly, another buffer layer 122 can be positioned between the hydroscopic material layer 118 and the passivation layer 120, as shown in FIG. 7, to prevent the moisture and oxygen gas penetrating through the passivation layer 120 efficiently.

Moreover, when the hygroscopic material layer 118 of the AM-OLED 100 is merely positioned on the buffer layer 116 above the insulating layer 106, the AM-OLED 100 is called a top emission type OLED (TM-OLED) 130, as shown in FIG. 8. Since a light emitting route of the TM-OLED 130 has to penetrate through the hygroscopic passivation structure 114. If the hygroscopic material layer 118 of the hygroscopic passivation structure 114 is too thick, the glow of the TM-OLED 130 will be lowered, and therefore the hygroscopic material layer 118 is merely positioned on the insulating layer 106 to prevent the above-mentioned problem. The detailed method for forming the hygroscopic passivation structure 114 of the TMOLED 130 is stated as below. First, a CVD process is performed to form a buffer layer 116 on the metal layer 112, and then a RIE process is performed to remove a portion of the buffer layer 116 outside the display region of the TM-OLED 130 by utilizing a mask, as shown in FIG. 3. Then, a thermal plating process or an electron beam thermal plating process is performed to form a hygroscopic material layer 118 on the buffer layer 116 by utilizing a slit mask, and a passivation layer 120 is plated on the hygroscopic material layer 118 to accomplish the hygroscopic passivation structure 114 of the TMOLED 130.

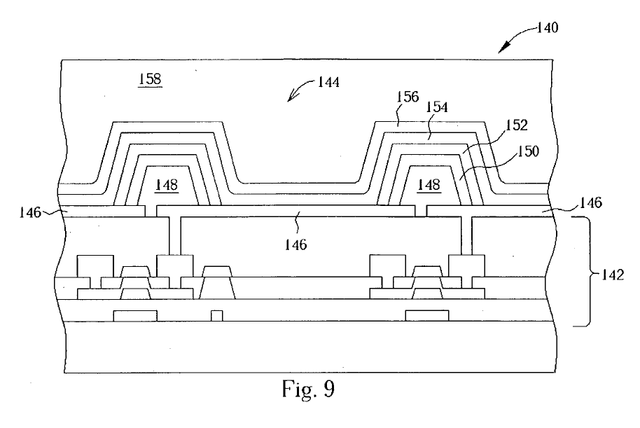

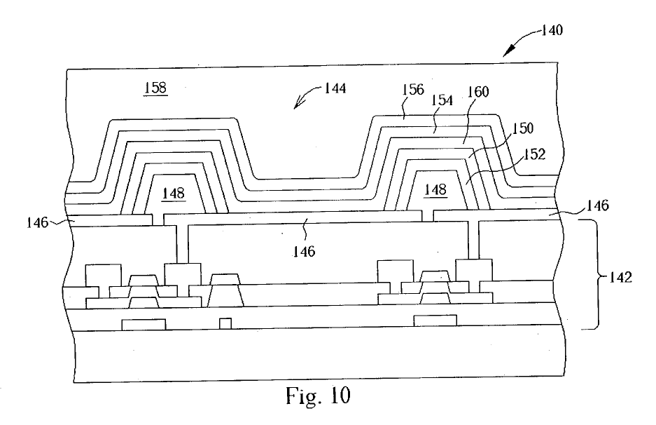

Please refer to FIG. 9 and FIG. 10, which are cross-sectional views illustrating another AM-OLED 140 according to the present invention. As shown in FIG. 9, the AM-OLED 140 mainly includes a TFT substrate 142, a plurality of active matrix type display units 144 positioned on the TFT substrate 142, a transparent conductive layer 146 positioned on the TFT substrate 142, a plurality of insulating layers 148 positioned on the TFT substrate 142 for separating each display unit 144, a hygroscopic material layer 150 positioned on the insulating layers 148, a buffer layer 152 positioned on the hygroscopic material layer 150, an organic layer 154 positioned on the buffer layer 152 and the transparent conductive layer 146, a metal layer 156 positioned on the organic layer 154, and a passivation layer 158 positioned on the metal layer 156. Typically, the insulating layers 148 are mostly composed of polymer materials, such as polymide in recent manufacturing processes of the AM-OLED 140. In order to prevent from affecting the organic layer 154 and the metal layer 156 due to the insulating layers 148 releasing moisture when the AM-OLED 140 is heated, the hygroscopic material layer 150 can be capped outside the insulating layers 148 to trap the moisture directly.

In addition, the hygroscopic material layer 150, the buffer layer 152, and the organic layer 154 can be positioned in turn according to demands of the OLED. As shown in FIG. 10, the buffer layer 152 is positioned on the insulating layers 148, and the hygroscopic material layer 150 is positioned on the buffer layer 152. Moreover, another buffer layer 160 can be positioned on the hygroscopic material layer 150 and the transparent conductive layer 146, and then the passivation layer 158, the metal layer 156, and the organic layer 154 can be positioned on the buffer layer 160, respectively. Therefore, the buffer layers 152 and 160 cover the hygroscopic material layer 150 completely to prevent the hygroscopic material layer 150 from peeling off when the hygroscopic material layer 150 reacts to the moisture.

In comparison with the conventional passivation structure of the OELD, the hygroscopic passivation structure of the present invention can trap the moisture penetrated through the outer passivation layer and the small amounts of moisture generated internally from the OLED by chemical adsorption. Therefore, the organic layer and the metal layer of the OLED are not destroyed by the moisture. In addition, the moisture trapped in the hygroscopic material layer is not only stored in the hygroscopic material layer, but a hydroxide chemical compound is generated after the hygroscopic material reacts to the moisture. Consequently, the moisture trapped in the hygroscopic material layer is not released easily when the OLED is in the high-temperature state, so as to increase the life of the OELD.

In summary, the hygroscopic passivation structure of the present invention including at least one buffer layer, a hygroscopic material layer, and a passivation layer is widely used in various light emitting devices, such as the flexible OELD, the AM-OLED, the PM-OLED, and the TM-OLED. In addition, the hygroscopic passivation structure of the present invention not only can adsorb the small amounts of moisture generated internally from the display device, but can also prevent the moisture from penetrating into the display device and affecting normal operation of the display device. Furthermore, the whole course for forming the hygroscopic passivation structure of the present invention is performed in a vacuum environment. Therefore, the display device does not make contact with the outside environment before the encapsulation process is completed, and the internal part of the display device does not retain the moisture and oxygen gas after finishing the encapsulation process. Moreover, the buffer layer, the hygroscopic material layer, and the organic layer of the hygroscopic passivation structure of the present invention can be positioned in turn according to demands of the manufacturing process. Consequently, the hygroscopic passivation structure of the present invention has advantages of being used widely, simplifying the manufacturing process, having better adsorption ability, and prevention from moistening well.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A hygroscopic passivation structure of an organic electroluminescent display (OELD), comprising:
a first buffer layer positioned on a display region of the OELD;
a hygroscopic material layer positioned on the display region of the OELD; and
a passivation layer positioned on the display region of the OELD.

2. The hygroscopic passivation structure of claim 1 wherein the OELD is positioned on a substrate.

3. The hygroscopic passivation structure of claim 2 wherein the substrate comprises a glass substrate, a plastic substrate, or a metal substrate.

4. The hygroscopic passivation structure of claim 2 wherein the OELD comprises a plurality of passive matrix type display units or a plurality of active matrix type display units.

5. The hygroscopic passivation structure of claim 4 wherein each passive matrix type display unit and each active matrix type display unit both further comprise a transparent conductive layer positioned on the substrate, an organic layer positioned on the transparent conductive layer, and a metal layer positioned on the organic layer.

6. The hygroscopic passivation structure of claim 5 wherein the organic layer further comprises a hole transport layer (HTL) positioned on the transparent conductive layer, an emitting layer (EML) positioned on the HTL, and an electron transport layer (ETL) positioned on the EML.

7. The hygroscopic passivation structure of claim 4 further comprising a thin film transistor (TFT) positioned under and electrically connected to a corresponding active matrix type display unit.

8. The hygroscopic passivation structure of claim 7 wherein the OELD is a top emission type OELD, and the hygroscopic material layer is merely positioned on the display region of the OELD above each TFT.

9. The hygroscopic passivation structure of claim 1 wherein the first buffer layer comprises parylene or diamond-like carbon (DLC), and has a thickness of approximately 1 angstrom (Å) to 100 micrometers (μm).

10. The hygroscopic passivation structure of claim 1 wherein the hygroscopic material layer comprises calcium oxide (CaO), barium oxide (BaO), or magnesium oxide (MgO), and has a thickness of approximately 1 Å to 100 μm.

11. The hygroscopic passivation structure of claim 1 wherein the passivation layer comprises polymer materials, ceramic materials, or metal.

12. The hygroscopic passivation structure of claim 1 wherein the hydroscopic material layer is positioned on the first buffer layer, and the passivation layer is positioned on the hydroscopic material layer.

13. The hygroscopic passivation structure of claim 12 further comprising a second buffer layer positioned between the hydroscopic material layer and the passivation layer.

14. The hygroscopic passivation structure of claim 12 wherein the hygroscopic material layer is used to adsorb moisture generated internally from the OELD and penetrated through the passivation layer, and the first buffer layer is used to prevent from affecting normal operation of the OELD when the hydroscopic material layer reacts to the moisture.

15. The hygroscopic passivation structure of claim 1 wherein the first buffer layer is positioned on the hydroscopic material layer, and the passivation layer is positioned on the first buffer layer.

16. The hygroscopic passivation structure of claim 1 wherein the OELD further comprises a peripheral region.
